(19) United States
(12) Patent Application Publication
(10) Pub. No.: US 2002/0097125 A1
(43) Pub. Date: Jul. 25, 2002

(54) Method for optimizing transcranial magnetic stimulation cores and magnetic cores produced thereby

(76) Inventor: Kent Davey, New Smyrna Beach, FL (US)

Correspondence Address: Levisohn, Lerner, Berger & Langsam, Suite 2400, 757 Third Avenue, New York, NY, 10017, US

(21) Appl. No.: 09/873,622

(22) Filed: Jun. 4, 2001

Related U.S. Application Data
(60) Provisional application No. 60/209,736, filed on Jun. 5, 2000.

(51) Int. Cl. H01F 27/02

(52) U.S. Cl. 336/83

(57) ABSTRACT

Transcranial Magnetic Stimulation (TMS) is now a common diagnostic and treatment for many brain dysfunctions. A rapidly changing magnetic field induces an electric field which initiates an action potential. Ferromagnetic cores increase the efficiency of the stimulator unit. Choosing an optimal core size is a task which involves both the physics of fields as well as the physics of biostimulation. Both the inductance and resistance of the stimulator affect the induced transmembrane voltage. A technique is outlined for using a boundary element method to design an optimal stimulation core and an exemplary core devised by such technique is described.

### RELATED APPLICATIONS

This application claims domestic priority from U.S. Provisional Patent Application No. 60/209,736 filed Jun. 5, 2000, the teachings of which are fully incorporated herein.

### BACKGROUND OF THE INVENTION

1. Field of the Invention

The invention relates to therapeutic and diagnostic transcranial magnetic stimulation (TMS) in general, and more particularly to techniques for the development of magnetic cores for use in TMS and in other applications.

2. Description of the Related Art

Transcranial Magnetic Stimulation (TMS) is now a common diagnostic and treatment for many brain dysfunctions, as described by Eric M. Wasserman in “Repetitive Transcranial Magnetic Stimulation: An Introduction and Overview”, CNS Spectrums, Vol. 2, No. 1, Jan. 1997, pp. 21-25, the teachings of which are filly incorporated by reference herein. A rapidly changing magnetic field induces an electric field which initiates an action potential. Ferromagnetic cores increase the efficiency of the stimulator unit. Choosing an optimal core size is a task which involves both the physics of fields as well as the physics of biostimulation. Both the inductance and resistance of the stimulator affect the induced transmembrane voltage.

Magnetic stimulation requires moving enough charge through an electrically sensitive nerve membrane to depolarize it (see John Cadwell, “Optimizing Magnetic Stimulator Design”, Magnetic Motor Stimulation: Basic Principles and Clinical Experience, EEG Supplement 43, 1991, pp. 238-248, the teaching of which are fully incorporated by reference herein); this means that the membrane voltage must be increased from its normal resting negative potential. Many authors have attempted to offer guidelines for producing energy efficient stimulation coils, as well in the modeling of these coils. See, e.g., G. A. Mouchawar, J. A. Nyenhuis, J. D. Bourland, and L. A. Geddes, “Guidelines for Energy Efficient Coils: Coils Designed for Magnetic Stimulation of the Heart”, Magnetic Motor Stimulation: Basic Principles and Clinical Experience, EEG Supplement 43, 1991, pp. 255-267; C. W. Hess, K. M. Rosier, R. O. Heckmann, H. P. Ludin, “Magnetic Stimulation of the Human Brain: Influence of Size and Shape of the Stimulating Coil”, Motor Disturbances II, Academic Press Limited, London, U.K. 1990, pp. 31-42; A. Cantano, P. Noel, “Transcranial Magnetic Stimulation: Interest in the Excitation Threshold”, Acta Neurologica Belgica, vol. 97, 1997, p. 61; G. Cerri, R. Deleo, F. Moglie, A. Schiavoni, “An accurate 3-D model for magnetic stimulation of the brain cortex”, Journal of Medical Engineering and Technology, Vol. 1, 1995, pp. 7-16, the teachings of which are all fully incorporated by reference herein. Roth and Basser were among the first to actually model the stimulation of a single fiber by electromagnetic induction as described in their Work“a Model of the Stimulation of a Nerve Fiber by Electromagnetic Induction”, IEEE Transactions on Biomedical Engineering, vol. 37, 1990, pp. 588-596, the teaching of which is fully incorporated by reference herein.

The stimulation is achieved through a rapidly changing magnetic field through a ferromagnetic core. Ions are driven through a nerve membrane, increasing the intracellular potential from −90 mV to about −40 mV, at which point the sodium and potassium gates open causing the propagation of an action potential. The instant inventor and assignee has three prior U.S. patents in this field: U.S. Patent Nos. 5,725,471 to Davey et al., 6,086,525 to Davey et al., and 6,132,361 to Epstein et al., the teachings of which are fully incorporated by reference herein.

In designing a working transcranial magnetic stimulator, it is desired to achieve maximum nerve stimulation for a fixed amount of energy. In other applications for magnetic cores, it is also typically desirable to generate an ideal magnetic field for the application. While some core parameters (e.g., inner radius, outer radius, etc.) may be set via trial and error, there is a need in the area of TMS and magnetic cores in general for a method for optimizing the parameters of a magnetic core.

### SUMMARY OF THE INVENTION

It is an object of the invention to provide a method for optimizing the shape of a magnetic core to achieve maximum stimulation for a fixed energy.

It is another object of the invention to provide a magnetic core developed using the inventive method.

The above and other objects are achieved by the invention, which is a method of optimizing a magnetic core, the core having inner and outer radii and wire windings. The core radii are allowed to change parametrically in a nested loop. Core reluctance, number of turns, and winding resistance are computed for each position. The maximum induced membrane voltage is computed based on an equation developed by the inventor. Membrane voltage is fit to the inner and outer radii using a multi-variable spline analysis. A variable metric sequential quadratic program algorithm is used to compute the combination of inner and outer radii that maximizes the peak membrane voltage. Preferably, this last step is repeated with a Monte-Carlo starting guess algorithm to insure that the maximum obtained in a global maximum. More preferably, different wire sizes are selected and the method is repeated for each different wire size selected. The wire size which maximizes the membrane voltage is selected.

The invention also includes a magnetic core produced in accordance with this method.

### BRIEF DESCRIPTION OF THE DRAWINGS

FIG. 1 is a schematic of a core stimulator to be optimized.

FIG. 2 is a schematic of a circuit for an iron core magnetic stimulator.

FIG. 3 is a schematic of biological tissue demonstrating how a changing magnetic flux induces a voltage within a nerve fiber.

FIG. 4 is a schematic of two TMS cores under a tank of saline FIG. 5 is a chart showing a comparison of induced E field along the perpendicular bisector of the saline tank.

FIG. 6 is a schematic of an optimized Core shape using a litz winding.

FIG. 7 is a chart showing predicted membrane voltages for optimized and non-optimized cores.

### DESCRIPTION OF THE PREFERRED METHOD AND EMBODIMENT

### A. Problem Definition

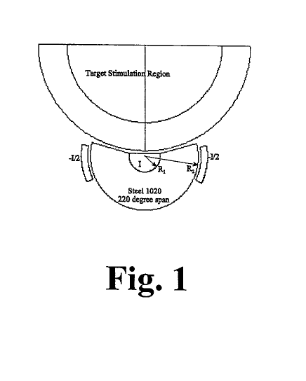

Shown in FIG. 1 is the TMS core to be optimized. The 1020 steel base is a tape wound core whose tape thickness is typically 2-4 mils thick. A changing magnetic field is driven into the target region to stimulate the induced E field. The depth of the core is dictated by the size of the target region, with a typical depth being 5 cm. The unknowns are the radii R₁ and R₂.

It is complicated to solve the problem, partly because the objective function is difficult to quantify. The core in FIG. 1 is excited by firing a thyrister allowing a charged capacitor to resonate one full cycle with the core inductance.

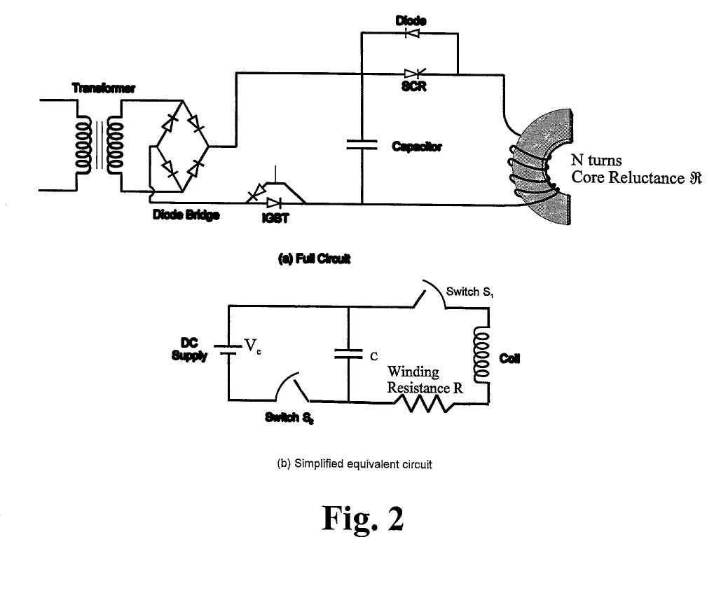

The power electronics of electromagnetic stimulator devices revolves around a capacitor driving current into the inductance of the stimulator core. The stimulator circuit is depicted in FIG. 2 with inset (a) being the full circuit, and inset (b) being a simplified equivalent. A dc charged capacitor C is allowed to resonate a complete cycle with the inductance comprising the core head. Were there no winding resistance, this would mean that the capacitive energy ½ CV² would shift to inductive energy ½ LI², and then reverse back into the capacitor; the full wavelength would require a time

τ=2π\sqrt{LC}

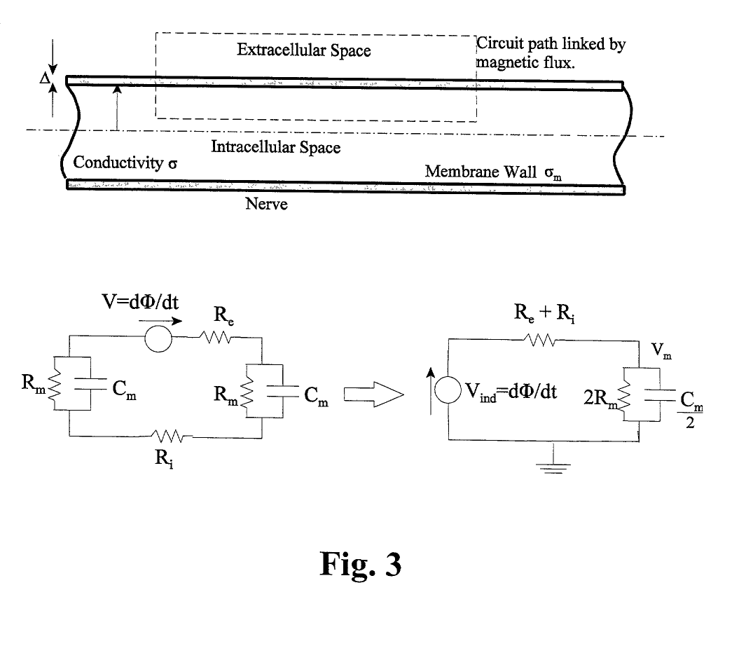

The magnetic flux from the inductor core is driven into biological tissue; the time changing flux will induce a voltage through the tissue linked by the flux. Of course only a fraction of that flux will link a circuit comprised of the intracellular and extracellular space around a nerve through the membrane wall. This biological circuit is depicted in FIG. 3. The induced voltage is only a fraction of the flux linking the iron core winding. The membrane is characterized by a low permeability/mobility to ion flow in its resting state. Note that the model focuses on a sub-threshold state over a long nerve length. The capacitance of the membrane wall can be expressed in terms of its permittivity 01 for a per unit axial length l as

$${C}_{m} = \frac{ϵ2π r l}{Δ} . \qquad ( 2 )$$

The membrane resistance Rₘ can be expressed in terms of the membrane wall thickness Δ as

$${R}_{m} = \frac{Δ}{{σ}_{m} 2 π r l} . \qquad ( 3 )$$

The intracellular resistance per unit length l is

$${R}_{i} = \frac{l}{{σ}_{i} π {r}^{2}} . \qquad ( 4 )$$

The extracellular resistance Rₑ is very small since the volume of the extracellular space is large.

### B. Analysis Preparation for the Optimization

The problem degenerates to solving both a magnetic circuit and a coupled biological circuit. Because the current in the biological tissue is so very small, the problem is not truly a coupled circuit problem since the biological circuit current does not affect the magnetic circuit. The current i in the magnetic circuit satisfies the differential equation

$$L \frac{ⅆ {i}^{2}}{ⅆ {t}^{2}} + R \frac{ⅆ i}{ⅆ t} + \frac{i}{C} = 0 , \\ \frac{ⅆ i}{ⅆ t} ( t = 0 ) = \frac{{V}_{C}}{L} , i ( t = 0 ) = 0. \qquad ( 5 )$$

Taking the Laplace transform and using I(s) for the transformed current yields the following

$$I ( s ) = \frac{{V}_{C}}{{Ls}^{2} + Rs + \frac{1}{C}} . \qquad ( 6 )$$

The flux linking the magnetic core winding is a function of the reluctance [symbol] of the magnetic circuit and the turns N as

$$Φ = \frac{N I}{ℛ} . \qquad ( 7 )$$

The induced voltage in the biological circuit will be related to a small fraction f of the total flux through its time rate of change; in Laplace domain space, this becomes

$${V}_{ind} = \frac{ⅆ}{ⅆ t} ( \frac{f N I}{ℛ} ) = \frac{sfNI ( s )}{ℛ} . \qquad ( 8 )$$

Thus the induced voltage becomes

$${V}_{ind} ( s ) = \frac{{sfNV}_{C} / ℛ}{{Ls}^{2} + Rs + \frac{1}{C}} . \qquad ( 9 )$$

Of particular interest is the nerve membrane voltage Vₘ. Kirchoff's voltage law written for the biological circuit is

$$\frac{{V}_{m} - {V}_{ind}}{{R}_{i} + {R}_{e}} + \frac{{V}_{m} {C}_{m} s}{2} + \frac{{V}_{m}}{2 {R}_{m}} = 0. \qquad ( 10 )$$

Rearranging terms yields the result

$${V}_{m} = \frac{{fsNV}_{C} / ℛ ( \frac{2 {R}_{m}}{2 {R}_{m} + {R}_{i} + {R}_{e}} )}{( {Ls}^{2} + R s + \frac{1}{C} ) ( 1 + s {τ}_{m} )} , \qquad ( 11 )$$

where

$${τ}_{m} = \frac{{C}_{m} {R}_{m} ( {R}_{l} + {R}_{e} )}{2 {R}_{m} + {R}_{l} + {R}_{e}} \approx {C}_{m} {R}_{m} = \frac{ϵ}{{σ}_{m}} .$$

Here the limit has been taken for large l, where τₘ is dependent only on the constitutive properties of the membrane. The energy W delivered to the magnetic circuit is

$$W = \frac{1}{2} {CV}_{C}^{2} , \qquad ( 12 )$$

and the resonant resistance free frequency is

$$ω = \frac{1}{\sqrt{L C}} . \qquad ( 13 )$$

In terms of these variables the numerator multiplier of (11) can be rewritten in terms of energy as

$${sfNV}_{C} / ℛ = sf \sqrt{\frac{L}{ℛ}} {V}_{C} = sf \sqrt{LC} \frac{\sqrt{C } {V}_{C}}{C \sqrt{ℛ}} = sf \frac{\sqrt{2 W} ω L}{\sqrt{ℛ}} . \qquad ( 14 )$$

Here use has been made of the fact that L=N²/ [symbol] . For very short nerve fibers, Rₘ is a dominant resistance, but for very long fibers with large l, the limit examined in (11),

$$\frac{2 {R}_{m}}{2 {R}_{m} + {R}_{l} + {R}_{e}} \approx \frac{2 {R}_{m}}{{R}_{l}} . \qquad ( 15 )$$

For what follows, the resistance ratio (2 Rₘ)/Rᵢ will be absorbed into the factor f. Finally, the membrane voltage can be written in terms of the circuit energy W and the resonant frequency ω as

$${V}_{m} ( s ) = \frac{sf \sqrt{2 W} ω / \sqrt{ℛ}}{( {s}^{2} + \frac{s}{{τ}_{L}} + {ω}^{2} ) ( 1 + s {τ}_{m} )} , \qquad ( 16 )$$

where the term τ_{L} has been introduced to represent the L/R time constant. The inverse Laplace transform delivers the membrane voltage as a function of time,

$${V}_{m} ( t ) = f \sqrt{\frac{2 W}{ℛ}} ω {τ}_{L} ( 4 {ω}^{2} {τ}_{L}^{2} - 1 ) ) . \frac{( {e}^{- \frac{t}{2 {τ}_{L}}} cos ( β ) + \frac{{e}^{- \frac{t}{2 {τ}_{L}}} ( 2 {τ}_{L} {τ}_{m} {ω}^{2} - 1 ) sin ( β )}{\sqrt{4 {ω}^{2} {τ}_{L}^{2} - 1}} - {e}^{- \frac{t}{{τ}_{m}}} )}{4 {ω}^{4} {τ}_{m}^{2} {τ}_{L}^{3} + {ω}^{2} ( 4 {τ}_{L}^{3} - {τ}_{m}^{2} {τ}_{L} ) + ( {τ}_{m} - {τ}_{L} )} ,$$

Equation (17) describes the connection

where

$$β ≡ \frac{1}{2} \sqrt{\frac{4 {ω}^{2} {τ}_{L}^{2} - 1}{{τ}_{L}^{2}}} t . \qquad ( 17 )$$

between the core reluctance, the number of turns, the winding resistance, and the induced membrane voltage.

### C. Core Optimization

The core optimization should be approached assuming that the starting energy of the system ½ CV² is held constant. In addition to the two unknowns R₁ and R₂ in FIG. 1, there is the additional unknown of what wire size to use. Within limits, heating is not an issue in this problem; most TMS applications allow ample time for the core to cool between treatment/diagnostic sessions. Core optimization is sought by

a. Choosing a wire size.

b. Allow the core radii to change parametrically in a nested loop.

c. Compute the core reluctance, number of turns, and winding resistance for each position.

d. Compute the maximum induced membrane voltage based on (17).

e. Fit the membrane voltage to the parameters R₁ and R₂ using a multi-variable spline analysis (a similar technique is shown by the inventor in “Use of Tensor Product Splines in Magnet Optimization”, IEEE Transactions on Magnetics, Vol. 35, No. 3, pp. 1714-1717, May 1999, the teachings of which are fully incorporated by reference herein).

f. Use a variable metric sequential quadratic program algorithm to compute the combination of R₁ and R₂ that maximizes the peak membrane voltage (a similar technique is shown by the inventor in “Magnet Design Optimization Using Variable Metrics,” IEEE Transactions on Magnetics, vol. 31, no. 6, pp. 3566-3568, 1995, the teachings of which are fully incorporated by reference herein).

g. Repeat step f repeatedly with a Monte-Carlo starting guess algorithm to insure that a global maximum, rather than a local maximum is found.

h. Repeat steps b-g for a different wire size. Each wire size will register an optimal membrane voltage; the maximum membrane voltage is sought.

The wire size is actually limited due to other factors. Wire smaller than #10AWG gets too hot even for the intermittent usage characterized by TMS. Wire larger than #8 does not fit into FDA (Food and Drug Administration) approved connectors adopted at Neotonus, Inc. Three wire sizes surface as potential candidates, #6 stranded, #8 stranded, and #8 litz.

The reluctance is found from boundary element analysis by means of a methodology described by the inventor in “Rotating Field Analysis Using Boundary Element Methods”, IEEE Transactions on Magnetics, Vol. 35, No. 3, pp. 1402-1405, May 1999 (the teachings of which are filly incorporated by reference herein) for the core treated as a one-turn inductance through the relation

$$L = \frac{2 {\int }_{V} \vec{A} \cdot \vec{J} ⅆ V}{{I}^{2}} , \qquad ( 18 )$$

and the fact that L=N²/ [symbol] . The reader may raise the objection that field focusing, and not just the reluctance of the core is critical in this application. The problem with the objection is that the secondary (the body) is one large interconnected circuit.

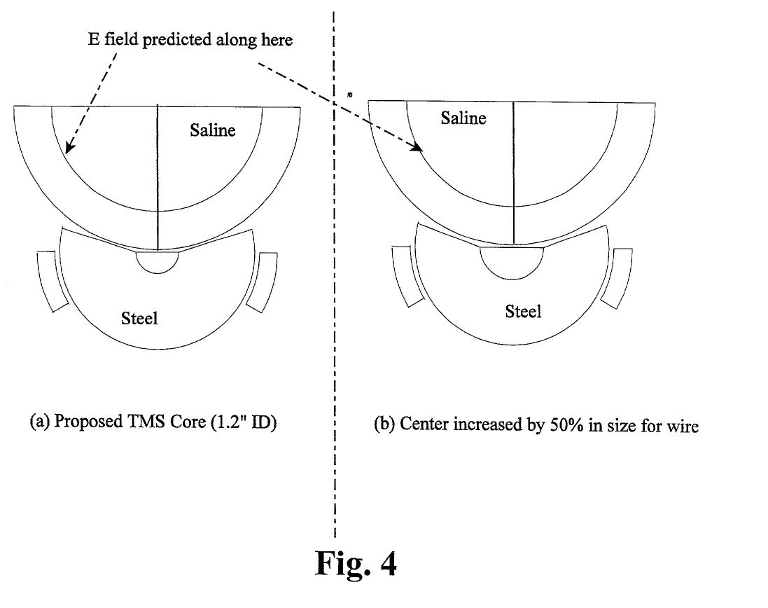

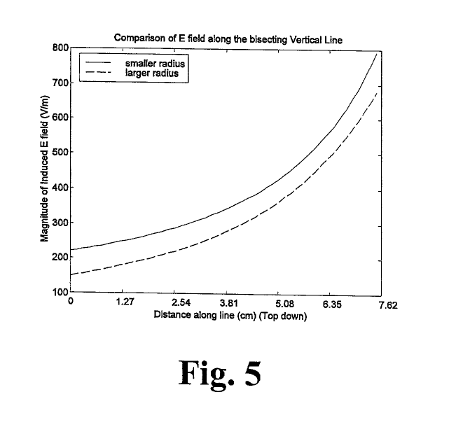

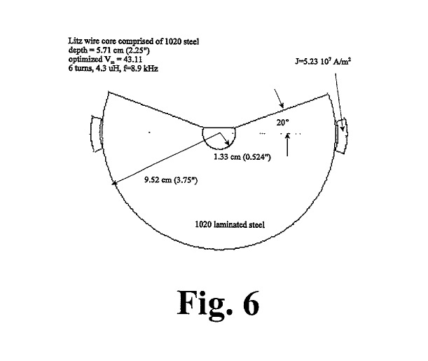

Because of the interconnectivity of the body tissue, focusing is less important than one might suspect. By way of demonstrating this point, consider the induced electric field in a saline tank for the two cores shown in FIG. 4. Inset (b) core has a smaller reluctance, a higher resonant frequency, and a larger current through the center hole. Despite this fact, the induced E field along the perpendicular bisector is smaller for the “more focused” core. The induced E field along the perpendicular bisector is shown in FIG. 5. The results clearly indicate that getting a lot of flux into the body tissue is important, and that basing the stimulator performance on the net reluctance is not a bad goal.

### D. Example

The optimization was performed on a 220° cut core made of laminated 1020 steel. As should be clear from (17), the resistance of the winding causes a resistive decay, which reduces the maximum membrane voltage. This resistive L/R decay will limit the outer diameter of the core. But it will limit the outer diameter(OD) to be less than 9.5 cm only if the resistivity of the wire is quadrupled. With copper wire, the optimization hits an artificial imposed weight constraint for the OD, but the ID was selected through the optimization algorithm.

The optimization was performed on three wires, #10 gauge stranded 15 kV having an OD=5.1 mm, #8 gauge stranded 15 kV wire with OD=6.35 mm, and #8 gauge 10 kV litz wire with OD=7.11 mm. The resistivity for the stranded wires was adjusted to be correct for 8 kV. Since each wire carried the same current, the current density was adjusted appropriately for the wire size, assuming a 60% packing factor. The reluctance (reciprocal one turn inductance) was then computed for a spectrum of core ID and OD combinations. Using the procedure outlined above, the optimal membrane voltage, and core position can be computed. The optimized litz wire core had the superior membrane voltage index (assuming f=1) at 43.11 with the #10 stranded wire core and the #8 stranded wire core following respectively at 43.017 and 42.59.

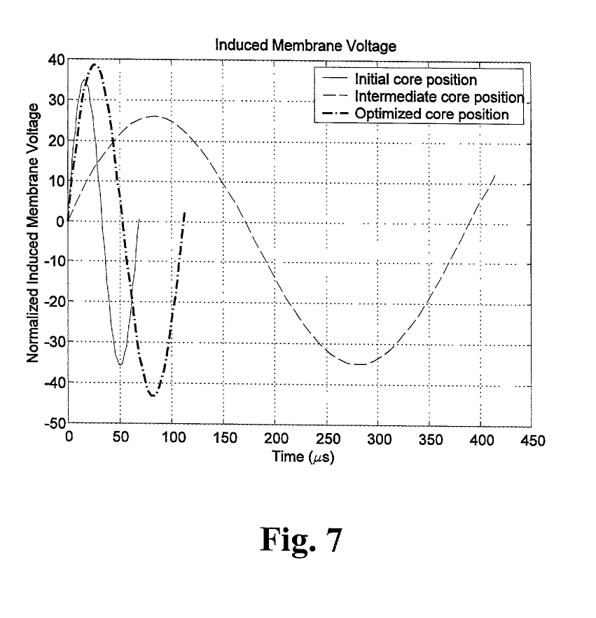

Shown in FIG. 7 is the predicted optimized membrane voltage versus time. Note the fact that the second valley has a greater absolute value than the first peak. The initial small and large cores respectively result in higher and lower resonant frequencies as expected. The initial core position had a smaller ID and OD, and thus a smaller inductance. The intermediate position corresponded to a much larger ID with more turns, and thus to a larger inductance, with a lower resonance frequency.

An optimization index is defined and tested for predicting the best nerve stimulation core. The optimization based on constant energy is based on the interplay of several factors affecting the induced internal membrane voltage, among the more important being the core winding resistance and reluctance. Depth and field focusing appear to play secondary roles in the proper design of a nerve stimulator. Litz wire having the lowest resistance offers the most optimal core for achieving the membrane voltage at a fixed energy.

The invention is not limited to the above description but rather is defined by the claims appearing hereinbelow. Modifications to the above description that include that which is known in the art are well within the scope of the contemplated invention. For example, the inventive method is described above as being used for TMS magnetic cores, however the method is adaptable to all forms of magnetic cores regardless of application.

What I claim is:

1. A method of optimizing a magnetic core, the core having inner and outer radii and wire windings, comprising the steps of:
a) allowing the core radii to change parametrically in a nested loop;
b) computing core reluctance, number of turns, and winding resistance for each position;
c) computing the maximum induced membrane voltage based on the following equation:
$${V}_{m} ( t ) = f \sqrt{\frac{2 W}{ℛ}} ω {τ}_{L} ( 4 {ω}^{2} {τ}_{L}^{2} - 1 ) ) . \frac{( {e}^{- \frac{t}{2 {τ}_{L}}} cos ( β ) + \frac{{e}^{- \frac{t}{2 {τ}_{L}}} ( 2 {τ}_{L} {τ}_{m} {ω}^{2} - 1 ) sin ( β )}{\sqrt{4 {ω}^{2} {τ}_{L}^{2} - 1}} - {e}^{- \frac{t}{{τ}_{m}}} )}{4 {ω}^{4} {τ}_{m}^{2} {τ}_{L}^{3} + {ω}^{2} ( 4 {τ}_{L}^{3} - {τ}_{m}^{2} {τ}_{L} ) + ( {τ}_{m} - {τ}_{L} )} ;$$
where
$$where β ≡ \frac{1}{2} \sqrt{\frac{4 {ω}^{2} {τ}_{L}^{2} - 1}{{τ}_{L}^{2}}} t .$$
d) fitting a membrane voltage to the inner and outer radii using a multi-variable spline analysis; and
e) using a variable metric sequential quadratic program algorithm to compute the combination of inner and outer radii that maximizes the peak membrane voltage.

2. A method according to claim 1 further comprising the step of:
f) repeating step e) with a Monte-Carlo starting guess algorithm, wherein said step f) insures that a global maximum is found.

3. A method according to claim 1, wherein said method is performed with a preselected wire size.

4. A method according to claim 1, further comprising the initial step of selecting a wire size.

5. A method according to claim 2, further comprising the initial step of selecting a wire size.

6. A method according to claim 4, further comprising the steps of:
g) selecting different wire sizes, and
h) repeating steps a-f for each different wire size selected.

7. A method according to claim 5, further comprising the steps of:
g) selecting different wire sizes, and
h) repeating steps a-f for each different wire size selected.

8. A method according to claim 6, further comprising the step of:
i) selecting the wire size which maximizes the membrane voltage.

9. A method according to claim 7, further comprising the step of:
i) selecting the wire size which maximizes the membrane voltage.

10. A magnetic core produced by the method of claim 1.
